(19) United States
(12) Patent Application Publication
(10) Pub. No.: US 2022/0036352 A1
(43) Pub. Date: Feb. 3, 2022

(54) SYSTEMS AND METHODS FOR ENABLING SELECTIVE ACTIVATION OF RESOURCE-DRAINING PROCESSES

(71) Applicant: POPULUS FINANCIAL GROUP, INC., Irving, TX (US)

(72) Inventors: Paul DE VOS, Dallas, TX (US); Joseph TAYLOR, Sachse, TX (US); Shirish GADRE, Coppell, TX (US)

(73) Assignee: POPULUS FINANCIAL GROUP, INC., Irving, TX (US)

(21) Appl. No.: 16/941,469

(22) Filed: Jul. 28, 2020

(51) Int. Cl. G06Q 20/40; G06Q 20/10

(52) U.S. Cl. CPC G06Q 20/40; G06Q 20/108

(57) ABSTRACT

Systems and methods configured for receiving a first signal from a user device associated with a user account; modifying a data record linked to the user account to unsuspend a protection program for the user account in response to the first signal; receiving a first request from a transaction processing system charging a first amount against the user account, the first amount being greater than a current balance of the user account; and processing the first request by: generating an authorization signal for the transaction processing system approving the first amount; modifying the data record to reflect a first balance corresponding to a difference between the current balance and the first amount; and generating a first notification signal for the user device based on the first request.

### TECHNICAL FIELD

The present disclosure generally relates to computerized systems and methods for enabling selective activation of resource-draining processes. In particular, embodiments of the present disclosure relate to inventive and unconventional systems that minimize resource utilization and improve scalability by enabling selective activation of certain processes that occur frequently.

### BACKGROUND

Financial institutions have become integral parts of peoples' lives, enabling safe storage of monetary assets, quick and convenient access to the assets, and flow of money between people and organizations. Various improvements to financial systems have included improvements to instruments such as credit cards, debit cards, and loans that make the flow of money even faster and more convenient. The improvements also include various services offered by the financial institutions that include those designed to minimize friction in processing different transactions, such as overdraft protection services.

A customer's financial account is overdrawn when a transaction is made that debits, from the account, an amount greater than its current balance. The financial institution holding the customer's account has two options when such transactions are made. First, the financial institution can reject the transaction, preventing the transaction from being processed so that the customer can attempt the transaction again with another method of payment. Alternatively, the financial institution can accept the transaction, allowing the transaction to be processed but leaving the account to be overdrawn (e.g., having a negative balance). The difference between the transaction amount and the current balance is covered by the financial institution with what is effectively a temporary loan to the customer. Some financial institutions may charge an overdraft fee as a penalty for spending more than the customer's current balance and/or as a fee for taking out the temporary loan.

The financial and legal implications created by such processes and special programs that offer those processes necessitate formal enrollment processes. The enrollment processes may involve reviewing terms and conditions of the special programs, obtaining customers' consent, and updating customer records to reflect the enrollment. Each of these tasks often involves a complex network of backend systems that consume network resources. While the amount of resource consumed by such enrollment processes may be negligible at individual customer level, the collective amount of resources consumed by hundreds of thousands or millions of customers can add up to place a sizable load on the network systems.

The tasks included in the enrollment processes also interfere with customer experience, where customers must consent to the terms and conditions every time the customer wishes to enroll. The enrollment processes may also include obtaining an approval from the financial institutions or meeting eligibility criteria, adding delay and inconvenience for the customer. This may deter customers from enrolling or unenrolling from such services as needed, forcing them to incur additional expenses that lead to lower customer satisfaction.

There is thus a need for the ability to activate or deactivate services any time customers want without enrolling or unenrolling from the services. Savings from not having to enroll or unenroll from the services would also bring technical improvements that minimize network load and improve scalability.

### SUMMARY

One aspect of the present disclosure is directed to a system comprising: a server comprising a data record linked to a user account, the user account being associated with a current balance; at least one non-transitory computer-readable medium configured to store instructions; and at least one processor configured to execute the instructions to perform operations. The operations may comprise: receiving a first signal from a user device associated with the user account; modifying the data record to unsuspend a protection program for the user account in response to the first signal; receiving a first request from a transaction processing system charging a first amount against the user account, the first amount being greater than the current balance; and processing the first request by: generating an authorization signal for the transaction processing system approving the first amount; modifying the data record to reflect a first balance corresponding to a difference between the current balance and the first amount; and generating a first notification signal for the user device based on the first request.

Another aspect of the present disclosure is directed to a method comprising: receiving a first signal from a user device associated with a user account; modifying a data record linked to the user account to unsuspend a protection program for the user account in response to the first signal; receiving a first request from a transaction processing system charging a first amount against the user account, the first amount being greater than a current balance of the user account; and processing the first request by: generating an authorization signal for the transaction processing system approving the first amount; modifying the data record to reflect a first balance corresponding to a difference between the current balance and the first amount; and generating a first notification signal for the user device based on the first request.

Other systems, methods, and computer-readable media are also discussed herein.

### BRIEF DESCRIPTION OF THE DRAWINGS

FIG. 1 is a schematic block diagram illustrating an exemplary embodiment of a networked environment comprising computerized systems for processing transactions and managing enrollment and activation states, consistent with the disclosed embodiments.

FIG. 2 is a flowchart of an exemplary computerized process for handling inquiries from user devices for retrieving or updating user data, consistent with the disclosed embodiments.

FIG. 3 is a schematic block diagram illustrating an exemplary embodiment of various states of a program, consistent with the disclosed embodiments.

FIG. 4 is a flowchart of an exemplary computerized process for processing transactions based on enrollment and activation states, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods that minimize resource utilization and improve scalability by enabling selective activation of certain processes that occur frequently.

The disclosed embodiments may comprise several integrated elements: application-side code, external and internal gateways for routing Internet and intranet service calls, identity processing, orchestration of requests, sets of microservices to process information, and long-term database storage. The disclosed embodiments may cover various functions such as processing financial transactions; handling customer requests to enroll or unenroll from certain services; and handling customer requests to activate or deactivate the services. While the embodiments are described below with respect to financial institutions and overdraft protection programs in particular, such implementations are only exemplary, and the disclosed embodiments may be implemented to manage any services that require a resource-consuming enrollment process.

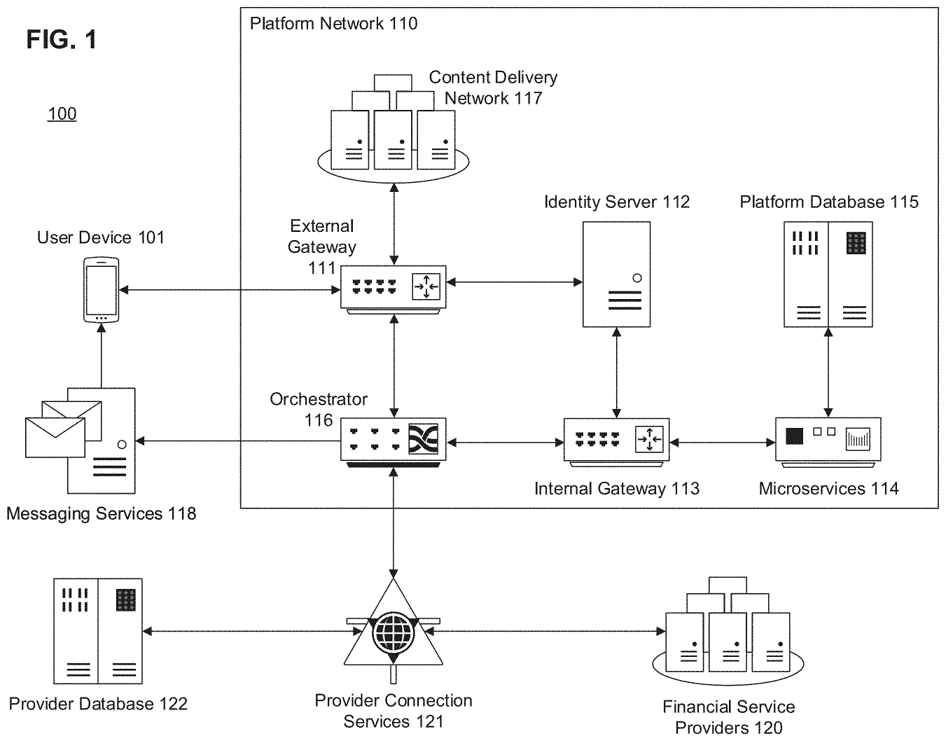

FIG. 1 is a schematic block diagram illustrating an exemplary embodiment of a networked environment 100 comprising computerized systems for processing transactions and managing enrollment and activation states.

Networked environment 100 may comprise a variety of computerized systems, each of which may be connected to one another via one or more networks. For example, the depicted systems include a user device 101, platform network 110, messaging services 118, financial service providers 120, provider connection services 121, and provider database 122. In some embodiments, each of the elements depicted in FIG. 1 may represent a group of systems, individual systems in a network of systems, functional units or modules inside a system, individual devices, or any combination thereof. And in some embodiments, each of the elements may communicate with each other via one or more public or private network connections including the Internet, an intranet, a WAN (Wide-Area Network), a MAN (Metropolitan-Area Network), a wireless network compliant with the IEEE 802.11 Standards, a cellular network (e.g., 4G, LTE, or 5G), a wired network, or the like. The individual systems can also be located within one geographical location or be geographically dispersed.

User device 101, in some embodiments, may be any personal computing device configured to access platform network 110 via network connections such as a cellular network or a wireless network compliant with the IEEE 802.11 Standards. While a smartphone is depicted as an example, user device 101 may be a cellphone, a tablet, a computer, a laptop, a wearable device, or the like, with which an account holder can access platform network 110.

In some embodiments, user device 101 may be configured to display a user interface for receiving various user inputs, including but not limited to enrolling into an overdraft protection program (ODP), suspending or unsuspending ODP, and consenting to legal agreements. In further embodiments, user device 101 may also be configured to receive, generate, or display notifications for reminding a user to perform certain tasks (e.g., reminding to unsuspend ODP) or for informing the user of an event (e.g., notifying that a transaction is processed).

Platform network 110, in some embodiments, may be a group of systems comprising an external gateway 111, an identity server 112, an internal gateway 113, microservices 114, a platform database 115, an orchestrator 116, and a content delivery network 117, each of which may be connected to one another via one or more networks enumerated above. Portions of other systems described below such as a messaging services 118, a provider connection services 121, and a provider database 122 may also be a part of platform network 110.

In some embodiments, the group of systems comprising platform network 110 may be owned and operated by a private entity serving as a platform for a plurality of users. Examples of such private entity may include a financial institution that provides financial accounts (e.g., checking account, prepaid debit card account, savings account) to users acting as account holders, and interfaces with financial service providers 120 to facilitate financial transactions. As such, platform network 110 may be protected with layers of firewalls and security policies to guard user identity and financial data stored therein.

External gateway 111, in some embodiments, may include one or more computing devices configured to accept incoming communications from user device 101 and relay them to appropriate systems. Internal gateway 113, in some embodiments, may be similar to external gateway 111 except that internal gateway 113 serves as a relay for communications among the systems within platform network 110.

Both external gateway 111 and internal gateway 113 may be an application programming interface (API) management tool that acts as a reverse proxy to accept all API calls, aggregate the various services required to fulfill them, and return the appropriate result. In some embodiments, external gateway 111 and internal gateway 113 may be implemented using Akamai, Apigee, Kong, Akana, Mashery, Postman, Boomi, or any suitable platform for API management.

In some embodiments, the incoming communications from user device 101 may include various requests with respect to a user account associated with user device 101. For example, incoming communications may include a request to enroll into ODP, suspend ODP, or update the user account with additional configuration data.

In further embodiments, external gateway 111 may also be configured to request and receive premade contents from content delivery network 117 and relay the contents to user device 101. Functions of content delivery network 117 is described below in more detail.

Identity server 112, in some embodiments, may include one or more computing devices configured to collect, organize, and store information related to account holders and their accounts. For example, identity server 112 may comprise any combination of non-transitory storage media such as hard disk drives, solid state drives, and the like. In some embodiments, identity server 112 may store a list of user accounts (e.g., checking accounts, savings accounts) at a bank and identifying information such as login credentials, account identifiers, a list of user devices previously authenticated for the user accounts, and the like. All information stored in identity server 112 may be protected by multiple levels of encryption. In some embodiments, the encryptions may comprise, for example, using symmetric or asymmetric encryptions to secure communications between any pair of systems, using hash functions to confirm user credentials, and/or using volume encryptions to secure data stored in non-transitory computer-readable mediums. In further embodiments, the encryptions may use pseudo-random encryption keys of different lengths (e.g., 128-, 256-, 1024-, 2048-bit, or any longer bit length keys) and algorithms such as advanced encryption standard (AES), transport layer security (TLS), secure socket layer (SSL), or any other standard encryption algorithms.

Microservices 114, in some embodiments, may include one or more computing devices configured to receive internal requests, modify corresponding data record stored in platform database 115, or transmit requested information based on the corresponding data record. For example, microservices 114 may be configured to process incoming validation requests and return a value indicating whether the validation was successful or not. Such validation requests may comprise, for example, determining whether a user is permitted to make certain modifications to his or her account, or determining whether the account has enough funds to tender a transaction. In another example, microservices 114 may also be configured to process incoming action requests to modify a corresponding data record stored in platform database 115 or to retrieve certain information regarding an account. Such action requests may comprise, for example, a request for enrolling the corresponding user account to ODP by modifying a data record stored in platform database 115 or retrieving information related to the user account from platform database 115.

In further embodiments, microservices 114 may be implemented as a suite of modular services, where each of the modular services may provide a limited scope of functionality so that the platform network 110 may remain supportive of incremental, evolutionary, guided changes without impacting other components. Microservices 114 may also be configured to leverage distributed logging and notification services to monitor system health and security concerns at a fine granularity.

Platform database 115, in some embodiments, may include non-transitory storage media such as hard disk drives, solid state drives, and the like, configured to store information related to user accounts in relational and nonrelational paradigms. By way of example, platform database 115 may include Oracle databases, Sybase databases, or other relational databases or non-relational databases, such as Hadoop sequence files, HBase, or Cassandra.

In some embodiments, platform database 115 may serve as a central database where all information pertaining to user accounts are stored, as opposed to identity server 112, which only stores information pertaining to verifying identity of user accounts and devices. For example, platform database 115 may store, in addition to the list of user accounts and identifying information stored in identity server 112, account details such as current balance, user permissions, state information of ODP, and the like.

Orchestrator 116, in some embodiments, may include one or more computing devices configured to receive incoming communications from user device 101 via external gateway 111 and perform appropriate actions. The communications may have been authenticated and/or validated through identity server 112, internal gateway 113, and microservices 114 before they are received and processed by orchestrator 116. Orchestrator 116 may then process the communications from user device 101 to generate and relay an appropriate action request to microservices 114.

In further embodiments, orchestrator 116 may interface with external systems such as messaging services 118 and provider connection services 121 in order to transmit notification messages to user device 101 or facilitate processing of financial transactions with financial service providers 120, respectively. Configurations of messaging services 118 and provider connection services 121 are described below in more detail.

Content delivery network (CDN) 117, in some embodiments, may comprise a group of servers distributed in different locations. Each CDN may include a group of non-transitory storage media, such as hard disk drives, solid state drives, and the like, configured to store an identical (or nearly identical) set of premade contents such as legal agreements, terms and conditions of ODP, or the like. Some CDNs may also store each premade content in different languages based on the demographics of users that access respective CDN. Small CDNs may be located within different regions of a single country, while large CDNs may be spread across data centers around the world. CDNs may be used to provide premade content to users in different locations as quickly as possible by the nature of their availability in different geographical locations.

Messaging services 118 may comprise multiple components responsible for integrating with a 3^{rd} party platform to deliver push, SMS, or email notifications to user device 101. A message may be delivered to user device 101 via any number of protocols at the same time.

In some embodiments, orchestrator 116 and messaging services 118 may use user-defined HTTP callbacks triggered by system events that can provide real-time information. The system events may include, for example, state changes of ODP (e.g., from not enrolled state to enrolled state) or occurrences of overdraft transactions. Messaging services 118 may further comprise message queues that provide an asynchronous communications protocol, which allows the sender and receiver of messages to interact with the message queue at different times. Messages placed onto the queues may be stored until the recipient retrieves them.

Financial service providers 120 may refer to a collection of networked computing devices or networks that provide a connectivity infrastructure for enabling communication among various entities and financial transaction systems to process merchant transactions, money movement, and/or other traditional banking operations. In some embodiments, financial service providers 120 may be an Interbank Network (such as NYCE®, INTERAC®, or the like), while in others, financial service providers 120 may be other platforms that function as Banking as a Service (BaaS) models. For example, financial service providers 120 may receive debit transactions when an account holder purchases an item using a debit card associated with a user account stored at platform database 115.

Provider connection services 121, in some embodiments, may be a client-side proxy for microservices applications that allows components of platform network 110 and financial service providers 120 to send and receive communications. Provider connection services 121 may be configured to route the communications to the right destination and apply security policies as required by platform network 110 or each financial service provider 120.

Provider database 122, in some embodiments, may comprise non-transitory storage media, such as hard disk drives, solid state drives, and the like, configured to store relational mappings and partner models that correspond to data stored in platform database 115 but are modified to comply with requirements of each financial service provider 120. This separation between platform database 115 and provider database 122 may prevent the provider-specific data in provider database 122 from leaking into the platform-specific data in platform database 115 and keep platform network 110 agnostic of financial service providers' 120 platforms.

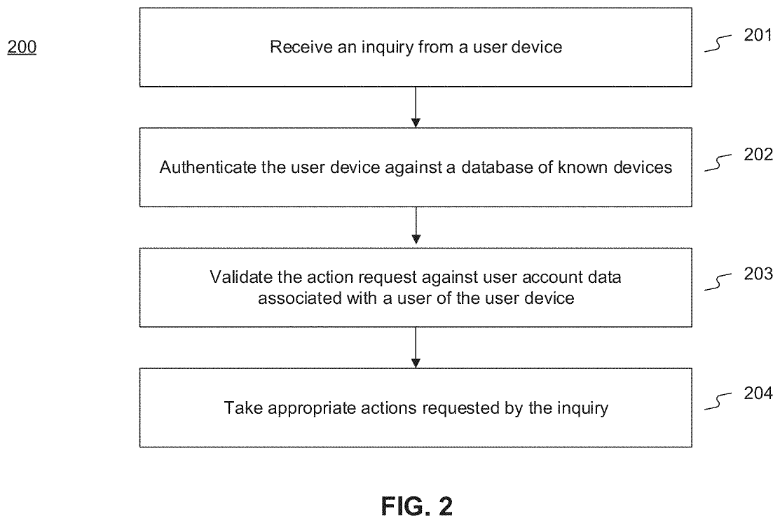

FIG. 2 is a flowchart of an exemplary computerized process 200 for handling inquiries from user device 101 for retrieving or updating user data. While many aspects of user data can be retrieved or updated using process 200, the embodiments disclosed below are directed to retrieving the state information of ODP for the user account associated with user device 101 or changing its state (e.g., enrolling, unenrolling, suspending, unsuspending).

In some embodiments, process 200 may be performed by platform network 110 using its subsystems (e.g., external gateway 111, identity server 112, internal gateway 113, microservices 114, platform database 115, and orchestrator 116) with the corresponding functions described above with respect to FIG. 1. While process 200 is described below with reference to specific subsystems of platform network 110, it should be understood that process 200 may be performed by a single system encompassing functions of each subsystem or a plurality of systems configured to include functions of any combination of the subsystems.

At step 201, external gateway 111 may receive an inquiry from user device 101. The inquiry may be a data communication (e.g., an API call) between user device 101 and external gateway 111 containing information necessary to retrieve or modify particular information regarding the user account associated with user device 101. In some embodiments, the inquiry may comprise various identifying information such as the identity of user device 101 and the identity of the user and/or the user account, as well as substantive information such as the information to be used to modify the user account or the information identifying the data to be retrieved. For example, the identity of user device 101 may comprise any one or more of the user device's MAC address, IP address, or any packet of data able to uniquely identify user device 101.

In some embodiments, user device 101 may generate the inquiries in response to user inputs associated with the user's interactions with user interface elements of user device 101. User device 101 may comprise input/output mechanisms such as a display, touchscreen, keyboard, mouse, or the like, which are configured to display graphical user interface (GUI) elements. These GUI elements may be associated with predefined actions that the user can initiate, such as retrieving account information, enrolling in ODP, or suspending ODP.

External gateway 111 may generate an authentication request in response to receiving the inquiry. The authentication request may be a data communication to identity server 112 for verifying that the user that sent the inquiry via user device 101 is indeed the expected user of user device 101 (e.g., the rightful owner instead of a malicious hacker).

At step 202, identity server 112 may, in response to the authentication request, authenticate user device 101 against a database of known devices stored in identity server 112 and previously authenticated for the user. Alternatively, when user device 101 does not match any of the known devices for the user, identity server 112 may try to authenticate user device 101 by sending a signal to the user through other, previously-authenticated means such as a text message to the user's mobile phone, an email, a call, or a message to a previously-authenticated device.

Having authenticated that the user behind user device 101 is the expected owner, identity server 112 may, via internal gateway 113, forward a validation request to microservices 114. At step 203, microservices 114 may process the validation request against user account data associated with the user and stored in platform database 115. In some embodiments, validation request may comprise user identity suitable for identifying the user account associated with the user. Microservices 114 may use such information, for example, to look up the user account in platform database 115, verify the user's permissions with respect to modifying different aspects of the user account, and/or confirm whether all requirements for retrieving or modifying user data are met.

Once the authentication request is verified and validated, microservices 114 may relay the completed authentication request to external gateway 111. In response, external gateway 111 may then generate an action request for processing the inquiry received from user device 101 at step 201. The action request, in some embodiments, may comprise instructions for retrieving information or modifying user data and identifying information for the user account as described above. In some embodiments, external gateway 111 may transmit the action request to orchestrator 116 for further processing, which may then be transmitted to microservices 114 via internal gateway 113 or to provider connection services 121.

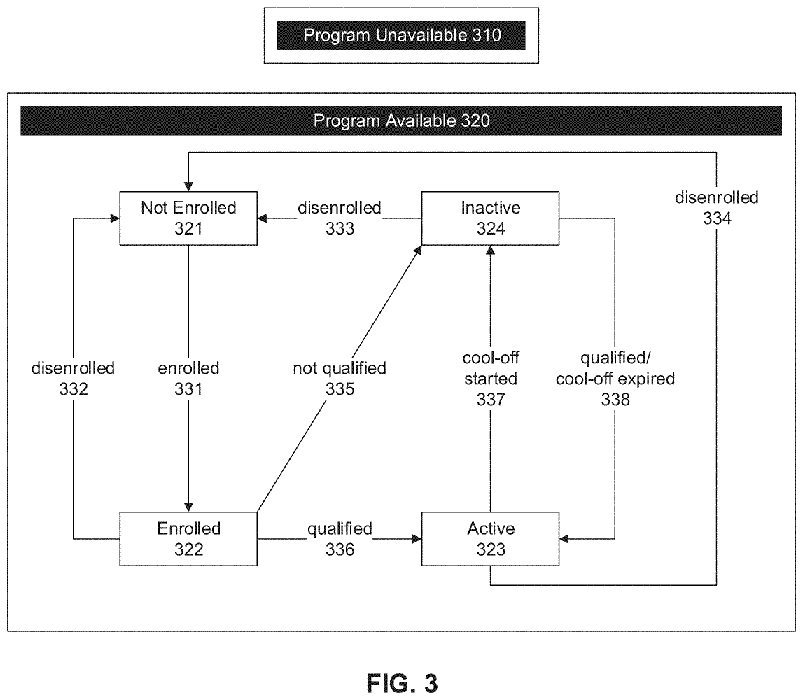

At step 204, microservices 114 and/or provider connection services 121 may take appropriate actions requested by the inquiry. In some embodiments, retrieving information regarding a user account may comprise looking up the user account in platform database 115 or the corresponding provider-specific user account data in provider database 122 and identifying the data record corresponding to the requested information. The requested information may include any static user account information such as contact information or user account information (e.g., account number, routing number, etc.) or any dynamic user account information such as the state information of ODP, which are described below in more detail with respect to FIG. 3.

Microservices 114 and/or provider connection services 121 may also be configured to add, remove, or update user account information as requested by the inquiry. Such change may involve identifying the data record corresponding to the information specified by the inquiry in platform database 115 or provider database 122 as described above, and adding, removing, or updating as appropriate. For example, enrolling in ODP may involve identifying the user account associated with user device 101, and changing a parameter associated with the enrollment state of ODP. Similarly, suspending ODP may involve identifying the user account and changing another parameter associated with the suspension state of ODP.

In further embodiments, the parameters updated by microservices 114 or provider connection services 121 above may trigger additional actions to be performed by platform network 110 and/or financial service providers 120, including but not limited to, for example, checking eligibility requirements of the user account or generating and transmitting notification messages relaying the results of the actions to user device 101 via messaging services 118.

This sequence of verification and validation of an authentication request followed by another action request to fulfill an inquiry may serve to put in place multiple layers of intentional redundancies that establish Defense in-Depth (DiD) authorization verifications to enable a zero-trust environment. More specifically, external gateway 111, identity server 112, internal gateway 113, microservices 114, and orchestrator 116 may each function as layers of DiD authorization verification that add intentional redundancies to increase the security of platform network 110 as a whole and address many different attack routes. This may also enable the zero-trust environment where no actors, systems, or services, even those operating within platform network 110, is automatically trusted and granted access. For example, the inquiry from user device 101 or an action request from orchestrator 116 initiated by another component (not shown) within platform network 110 may be required to establish a trust relationship by successfully passing a security challenge (e.g., a set of proper system level credentials that are cryptographically stored) in order to receive a valid authorization token. In some embodiments, identity server 112 may manage issuance of the valid authorization tokens, thereby limiting the number of times a security token needs to be issued and thus resulting in fewer decryption functions being executed, database retrievals, and tokens generated and tracked.

FIG. 3 is a schematic block diagram illustrating an exemplary embodiment of various states of a program such as ODP. The states depicted in FIG. 3 are only exemplary, and any number of different states and their combinations may be implemented for a particular program. In some embodiments, a particular user account may be situated at any one of the states and transition to another state in response to an inquiry initiated by the user, platform network 110, or financial service providers 120. While the embodiments are described below with references to components of networked environment 100, the processes or functions described herein may be performed by any other suitable system or a group of systems.

At the fundamental level, the states may divide into an unavailable state 310 and an available state 320. Unavailable state 310 may correspond to a situation where the program is not offered by platform network 110 or financial service provider 120 or is not available to the user in particular. In the latter case, platform network 110 or financial service provider 120 may decide to not offer the program to the particular user based on, for example, the user's credentials or credit worthiness. In some embodiments, there may be no other state within unavailable state 310 and a user may not be able to request transition to any other state, unless platform network 110 or financial service provider 120 decided to offer the program and transitioned the user account to available state 320.

Available state 320 may correspond to a situation where the program is offered. In some embodiments, available state 320 may include a not enrolled state 321, an enrolled state 322, an active state 323, and an inactive state 324. Not enrolled state 321 may correspond to a situation where the user account is not enrolled in the program. Once the user requests enrollment, user device 101 may generate an inquiry to enroll into the program as described above with respect to FIG. 2, after which point the user account may transition to enrolled state 322.

In some embodiments, enrolled state 322 may be a temporary state that transitions to either active state 323 or inactive state 324 based on whether the user account meets eligibility requirements of the program or not, respectively. More specifically, the user account may transition to active state 323 if the user account met the eligibility requirements at the time of enrollment. Alternatively, the user account may transition from enrolled state 322 to inactive state 324 if the user account does not meet the eligibility requirements at the time of enrollment. The user account may transition from inactive state 324 to active state 323 upon meeting the eligibility requirements at a later point in time.

In some embodiments, every transition between a pair of states may involve manipulation of data among different components of networked environment 100. For example, conversion step 331 corresponding to the transition from not enrolled state 321 to enrolled state 322 may trigger components of platform network 110 to retrieve terms and conditions of the program from CDN 117, obtain user's consent through user device 101, send an enrollment request to financial service provider 120 via orchestrator 116 and provider connection services 121, receive an enrollment confirmation from financial service provider 120, update the data record stored in platform database 115 and provider database 122 to reflect the enrollment, and transmit a notification message to user device 101 via messaging services 118. Conversion steps 332-334, corresponding to disenrolling from the program, may involve similar but opposite steps as conversion step 331 except for the omission of retrieving terms and conditions from CDN 117 and obtaining user consent.

Other conversion steps 335-338, corresponding to transitions among different ordered pairs of enrolled state 322, active state 323, and inactive state 324, may involve less steps than conversion step 331. Specifically, conversion steps 335 and 336 may involve microservices 114 or financial service providers 120 determining whether the user account meets all eligibility requirements of the program. The eligibility requirements may comprise, for example, having direct deposit set up, making certain number of debit transactions over a period of time, and/or maintaining an average balance over a certain minimum.

In addition, conversion steps 337 and 338 may involve orchestrator 116 or financial service provider 120 monitoring the parameters of the user account to determine whether the user account meets all eligibility requirements of the program, or monitoring transaction of the user account to determine when to engage a cool-off period. As used herein, the cool-off period may refer to a period where a user account in active state 323 is transitioned to inactive state 324 due to an over-utilization of the program or other violations of applicable terms and conditions. Orchestrator 116 or financial service provider 120 may transition a user account from active state 323 to inactive state 324 for a period of time while the cool-off period is engaged, as represented by conversion step 337, and transition the user account back to active state 323 once the cool-off period is over, as represented by conversion step 338.

While complex and involving series of steps that generate network load and consume network resources, organizing user accounts in different states as described herein may allow platform network 110 and financial service providers 120 to clearly identify all possible states that a user account may take. Furthermore, by distinguishing between inactive state 324, indicating the user's desire to be enrolled but not qualifying for the moment, and not enrolled 321, indicating the user's desire not to enroll, the user account may freely transition between inactive state 324 and active state 323 without having to consent to the terms and conditions every time the user wishes to take advantage of the program. Such configuration may spare platform network 110 and financial service providers 120 from having to expend resources to present the terms and conditions and obtain user consent. The configuration may also lead to a higher user satisfaction by eliminating the need for the legal process.

In some embodiments, each conversion step may also involve using messaging services 118 to transmit a notification message to user device 101 indicating the current state of the user account. This allows accurate and transparent communication of the state to the users, putting them in clear notice of the program and thus improving user satisfaction.

In further embodiments, within each of enrolled state 322, inactive state 324, and active state 323, users may be able to selectively toggle between suspended state (not shown) and unsuspended state (not shown). Despite the advantages of having various states as disclosed above, having orchestrator 116 and financial service providers 120 constantly monitoring user accounts for determining eligibility or over-utilization leads to unnecessary expenditure of resources that decrease scalability of the disclosed embodiments. Some users may also desire to suspend the program temporarily at times, which is not possible without completely unenrolling from the program in the above disclosed embodiments.

Having a suspended state and an unsuspended state in each of enrolled state 322, inactive state 324, and active state 323 allows temporary suspension of the program at will, which also suspends the tasks associated with each state (e.g., monitoring user accounts, transactions, or the like), thereby reducing unnecessary expenditure of resources. It also allows the user to unsuspend the program at will without having to go through the full enrollment process again, which further reduces unnecessary expenditure and improves user satisfaction.

In some embodiments, toggling between the suspended state and unsuspended state may begin with receiving a first signal from user device 101 associated with a user account, similar to receiving an inquiry described above with respect to step 201 of FIG. 2.

More specifically, the first signal may comprise an inquiry generated by user device 101 in response to a user input communicating an intent to toggle between the suspended state and the unsuspended state. The user input may comprise interacting with GUI elements such as a switch, a button, or a checkbox, or inputting textual or voice commands. As described above in FIG. 2, the first signal (i.e., the inquiry) may be a data communication (e.g., an API call) to external gateway 111 containing information necessary to modify the state information of a program for the corresponding user account.

Platform network 110 may then authenticate and validate the inquiry as described above with respect to steps 202 and 203, and proceed to modifying the data record associated with the user account to suspend or unsuspend the program for the user account in respond to the inquiry. Modifying the data record may involve a process similar to step 204 described above.

Compared to previous embodiments where the user must have disenrolled from the program in order to transition away from enrolled state 322, active state 323, or inactive state 324 in order to stop the program, suspending the program as disclosed herein may allow the user to stop the program without transitioning to not enrolled state 321. This allows the user to bypass the requirements for review the terms and conditions and providing consent upon reactivating the program.

In some embodiments, orchestrator 116 may periodically generate a notification message to user device 101 via messaging services 118, reminding user that the program is currently suspended and/or to suggest unsuspending the program. Additionally or alternatively, orchestrator 116 may be configured to automatically unsuspend the program after a predetermined period of time.

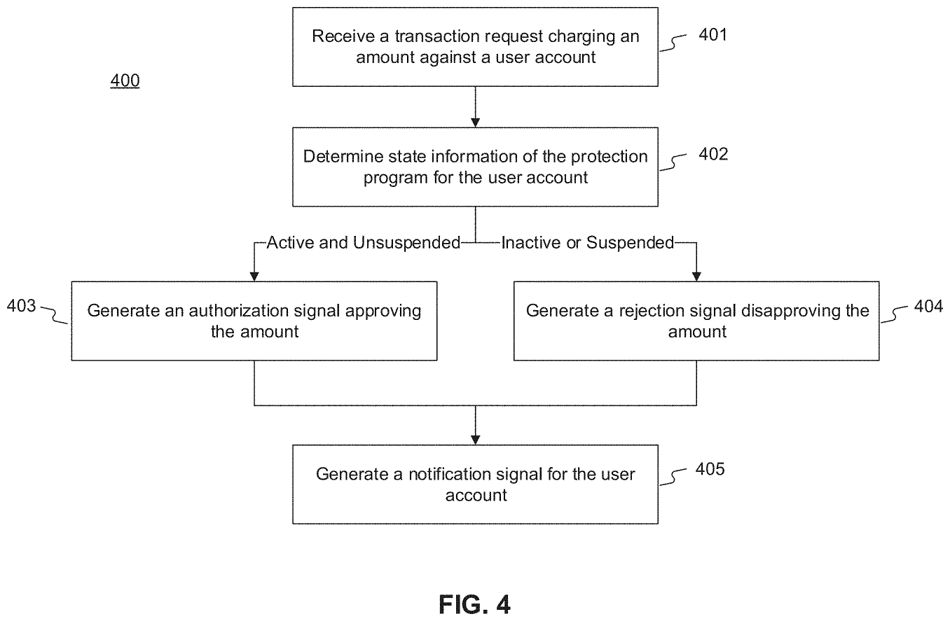

FIG. 4 is a flowchart of an exemplary computerized process 400 for processing transactions based on states information of ODP. While process 400 is described below with respect to ODP, such description is only exemplary and process 400 may be applicable to any other program.

At step 401, platform network 110 may receive a transaction request from financial service provider 120, charging an amount against the current balance of the user account. An amount less than the current balance may simply be approved by platform network 110 or financial service providers 120, decreasing the current balance by the transaction amount. On the other hand, an amount greater than the current balance may lead to overdrawing the user account.

For transactions that will end up overdrawing the user account, orchestrator 116 or financial service provider 120 may, at step 402, determine the state information of ODP for the user account. The state information may comprise any of the different states described above with respect to FIG. 3.

If the state information indicates that the program is in active state 323 and unsuspended, orchestrator 116 may, at step 403, generate an authorization signal approving the amount, despite the fact that the current balance is insufficient to cover the transaction amount. The orchestrator may also generate an action request to microservices 114 to deduct the amount of the transaction from the current balance. On the other hand, if the state information is in any other state (i.e., unavailable state 310, not enrolled state 321, enrolled state 322, or inactive state 324) or the program is suspended, orchestrator 116 may, at step 404, generate a rejection signal disapproving the amount.

In some embodiments, orchestrator 116 may, at step 405, generate a notification message to user device 101 via messaging services 118. If the transaction was approved, the notification message may comprise, for example, details of the transaction, such as the transaction amount and resulting negative balance, as well as legal or financial obligations created by the overdraft, such as having to restore the balance to a positive number within a predetermined period of time. Alternatively, if the transaction was rejected, the notification message may comprise, for example, details of the transaction, such as the transaction amount, the current balance unaffected by the transaction, and/or a suggestion to unsuspend the program. In some embodiments where orchestrator 116 approved the overdraft transaction at step 403, orchestrator 116 may also generate an action request to microservices 114 after the predetermined period of time, imposing a penalty if the negative balance is still not cured.

Compared to previously disclosed embodiments without the option of suspended and unsuspended states, the embodiments disclosed above that enable selective suspension of the program may offer even further improvements. Such selective suspension may allow platform network 110 and financial service providers 120 to reduce network load and expend less resources by suspending additional tasks that platform network 110 and financial service providers 120 were required to perform. While the savings realized by the selective activation may be negligible with respect to individual users, the savings realized among hundreds of thousands or millions of users may accumulate to a significant advantage that improves scalability of the system. For example, Table 1 below shows exemplary tasks that are required for enrolling or disenrolling from ODP and suspending or unsuspending the ODP, and their respective packet sizes.

TABLE 1
Additional Tasks and Their Respective Packet Sizes

| Operation | Task | Argument(s) | Size (bytes) |
|---|---|---|---|
| Enroll | GetOverdraftStatus | Account Token | 72 |
| | EnrollOverdraft | Program Id, | 144 |
| | | Account Token | |
| Disenroll | DisenrollOverdraft | AccountToken | 72 |
| Suspend | SuspendOverdraft | SuspendStatus | 84 |
| | | AccountToken | |
| Unsuspend | UnsuspendOverdraft | SuspendStatus | 88 |
| | | AccountToken | |

As illustrated in Table 1 above, just enrolling to ODP requires generating and transmitting requests that are more than twice the size of suspending or unsuspending the program. Without the ability to suspend and unsuspend ODP, a user would need to disenroll completely and enroll again, requiring a series of steps that add up to be significantly more.

As such, the current embodiment with the ability to suspend the program replaces the number of times platform network 110 or financial service provider 120 must transition though not enrolled state 321, enrolled state 322, inactive state 324, and active state 323 with just a simple binary operation of suspending or unsuspending the program. Such binary operation may also be efficiently stored in cache with optimal retrieval characteristics, thereby further optimizing and reducing the traffic load.

In addition, where leveraging messaging services 118 incurs an actual monetary cost, the binary operation may reduce the number of state transitions that must take place and thus the number of notifications that must be sent to user device 101 or other systems through messaging services 118. The smaller number of state transitions may also reduce the amount of data required to manage the functionality of ODP, thereby reducing the amount of data storage and the associated operating cost.

Still further, not having to enroll into the program every time the user desires to take advantage of the program may remove compliance requirement for delivery of terms and conditions, which further reduces the cost of data transmission in compliance with the requirements in addition to removing inconvenience to users of reviewing and consenting to terms and conditions.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system comprising:
a server comprising a data record linked to a user account, the user account being associated with a current balance;
at least one non-transitory computer-readable medium configured to store instructions; and
at least one processor configured to execute the instructions to perform operations comprising:
receiving a first signal from a user device associated with the user account;
modifying the data record to unsuspend a protection program for the user account in response to the first signal;
receiving a first request from a transaction processing system charging a first amount against the user account, the first amount being greater than the current balance; and
processing the first request by:
generating an authorization signal for the transaction processing system approving the first amount;
modifying the data record to reflect a first balance corresponding to a difference between the current balance and the first amount; and
generating a first notification signal for the user device based on the first request.

2. The system of claim 1, wherein the operations further comprise:
receiving a second signal from the user device;
modifying the data record to suspend the protection program for the user account in response to the second signal;
receiving a second request from the transaction processing system charging a second amount, the second amount being greater than the current balance; and
processing the second request by:
generating a rejection signal for the transaction processing system declining the second amount; and
generating a second notification signal for the user device based on the second request.

3. The system of claim 2, wherein the operations further comprise:
periodically generating a third notification signal for the user device to unsuspend the protection program.

4. The system of claim 2, wherein the operations further comprise:
unsuspending the protection program for the user account after a predetermined period of time.

5. The system of claim 1, wherein the operations further comprise:
modifying the data record to reflect a penalty if the first balance is a negative value for a predetermined period of time.

6. The system of claim 1, wherein the operations further comprise:
modifying the data record to suspend the protection program for the user account in response to a plurality of third requests from the transaction processing system charging a corresponding number of overage amounts against the user account.

7. The system of claim 1, wherein the user device generates the first signal in response to a user interaction with the user device representing a change in the user account.

8. The system of claim 1, wherein receiving the first signal bypasses requirements for obtaining a user consent.

9. The system of claim 1, wherein the first notification signal comprises the first balance and one or more obligations raised by approving the first amount.

10. The system of claim 2, wherein the second notification signal comprises a reminder to unsuspend the protection program.

11. A method comprising:
receiving a first signal from a user device associated with a user account;
modifying a data record linked to the user account to unsuspend a protection program for the user account in response to the first signal;
receiving a first request from a transaction processing system charging a first amount against the user account, the first amount being greater than a current balance of the user account; and
processing the first request by:
generating an authorization signal for the transaction processing system approving the first amount;
modifying the data record to reflect a first balance corresponding to a difference between the current balance and the first amount; and
generating a first notification signal for the user device based on the first request.

12. The method of claim 11 further comprising:
receiving a second signal from the user device;
modifying the data record to suspend the protection program for the user account in response to the second signal;
receiving a second request from the transaction processing system charging a second amount, the second amount being greater than the current balance; and
processing the second request by:
generating a rejection signal for the transaction processing system declining the second amount; and
generating a second notification signal for the user device based on the second request.

13. The method of claim 12 further comprising:
periodically generating a third notification signal for the user device to unsuspend the protection program.

14. The method of claim 12 further comprising:
unsuspending the protection program for the user account after a predetermined period of time.

15. The method of claim 11 further comprising:
modifying the data record to reflect a penalty if the first balance is a negative value for a predetermined period of time.

16. The method of claim 11 further comprising:
modifying the data record to suspend the protection program for the user account in response to a plurality of third requests from the transaction processing system charging a corresponding number of overage amounts against the user account.

17. The method of claim 11, wherein the user device generates the first signal in response to a user interaction with the user device representing a change in the user account.

18. The method of claim 11, wherein receiving the first signal bypasses requirements for obtaining a user consent.

19. The method of claim 11, wherein the first notification signal comprises the first balance and one or more obligations raised by approving the first amount.

20. The method of claim 12, wherein the second notification signal comprises a reminder to unsuspend the protection program.
